(19) United States
(12) Patent Application Publication
(10) Pub. No.: US 2024/0006816 A1
(43) Pub. Date: Jan. 4, 2024

(54) CONNECTOR WITH ADJUSTABLE TOLERANCE AND METHOD FOR MANUFACTURING THE SAME

(71) Applicant: Continental Automotive Technologies GmbH, Hannover (DE)

(72) Inventor: Wongyoung Lee, Seoul (KR)

(73) Assignee: Continental Automotive Technologies GmbH, Hannover (DE)

(21) Appl. No.: 18/213,484

(22) Filed: Jun. 23, 2023

(30) Foreign Application Priority Data
Jun. 29, 2022 (KR) 10-2022-0079539

(51) Int. Cl. H01R 13/631; H01R 13/502; H01R 43/18

(52) U.S. Cl. CPC H01R 13/631; H01R 13/502; H01R 43/18

(57) ABSTRACT

Disclosed are a tolerance-adjustable connector and a method for manufacturing the same. The tolerance-adjustable connector comprises: a housing made of a first synthetic resin; and a movable guide that is made of a second synthetic resin that is not bonded to the first synthetic resin, is in slidable contact with the housing, and is movable relative to the housing.

### BRIEF DESCRIPTION OF THE DRAWINGS

FIG. 1 is a cross-sectional view of an exemplary tolerance-adjustable connector according to an aspect of the disclosure.

FIG. 2 is a cross-sectional view illustrating an exemplary state in which an exemplary opposing connector is inserted into and coupled to an exemplary tolerance-adjustable connector of FIG. 1.

FIGS. 3 to 5 are cross-sectional views sequentially illustrating an exemplary method for manufacturing an exemplary tolerance-adjustable connector of FIG. 1.

### DETAILED DESCRIPTION

The disclosure relates to a connector, and more particularly, to a connector having an adjustable tolerance so that an opposing connector may be easily inserted and coupled, and a method for manufacturing the same.

A connector is an electronic component that electrically connects a power source to a device, a device to a device, or units inside a device to each other. The connection of a typical connector may be configured so that a header of one connector may be inserted into and connected to a groove of another connector.

However, since a tolerance of the groove of the other connector and a tolerance of the header of the connector may be cumulative, it may be frequently the case that the coupling by inserting the header into the groove may not be possible. On the other hand, when a floating connector is applied, manufacturing costs greatly increase, and the size of the connector also increases, and thus, it may be difficult to design an electronic device provided with the connector to be small in size.

The disclosure solves the above problems and describes a connector having an adjustable tolerance so that an opposing connector may be easily inserted and coupled even when there may be a tolerance of the opposing connector or a positional tolerance of a terminal, and a method for easily manufacturing the tolerance-adjustable connector.

A tolerance-adjustable connector may comprise: a housing made of a first synthetic resin; and a movable guide that may be made of a second synthetic resin that may not be bonded to the first synthetic resin, may be in slidable contact with the housing, and may be movable relative to the housing.

One of the housing and the movable guide may be provided with a protrusion, the other of the housing and the movable guide may have a protrusion guide groove recessed in the protruding direction of the protrusion so that the protrusion may be inserted, and the movable guide may be movable substantially parallel to the protruding direction of the protrusion.

The movable guide may be provided as a plurality, a through-hole may be formed in the housing, and the plurality of movable guides may be slidably supported on an edge portion that defines the through-hole.

The tolerance-adjustable connector may further comprise a guide holder having a guide through-hole through which the movable guide passes and which may have a clearance so that the movable guide moves relative to the housing while the movable guide passes therethrough.

The movable guide may be provided with a hook at a distal end thereof so that the distal end of the movable guide passes through the through-hole in one direction and then cannot pass through in the opposite direction to said direction.

At least one of the first synthetic resin and the second synthetic resin may be polytetrafluoroethylene (PTFE).

The other of the first synthetic resin and the second synthetic resin may be one of an acrylonitrile butadiene styrene resin (ABS resin) and a polystyrene resin.

In addition, disclosed is a method for manufacturing a tolerance-adjustable connector, the method comprising: a double injection molding step of forming a semifinished connector product provided with a housing made of a first synthetic resin and a movable guide made of a second synthetic resin and temporarily attached to the housing through double injection molding; and a movable guide separation step of pressing the movable guide so that the movable guide may be separated from the housing to be able to move relative to the housing.

The melting point of the first synthetic resin may be higher than the melting point of the second synthetic resin, and the double injection molding step may comprise: a housing molding step of injection-molding the housing made of the first synthetic resin; and a semifinished connector product molding step of fixing the housing inside a mold having a cavity corresponding to a shape of a semifinished connector product and injecting the molten resin of the second synthetic resin into the cavity and curing same to mold the semifinished connector product.

The first synthetic resin may be PTFE.

The melting point of the second synthetic resin may be higher than the melting point of the first synthetic resin, and the double injection molding step may comprise: a movable guide molding step of injection-molding the movable guide made of the second synthetic resin; and a semifinished connector product molding step of fixing the movable guide inside a mold having a cavity corresponding to a shape of the semifinished connector product and injecting the molten resin of the second synthetic resin into the cavity and curing same to mold the semifinished connector product.

The second synthetic resin may be PTFE.

The method for manufacturing the tolerance-adjustable connector may further comprise: a guide holder preparation step of preparing a guide holder in which a guide through-hole having a clearance may be formed; and a guide holder installation step of installing the guide holder inside the housing so that the movable guide passes through the guide through-hole.

In the tolerance-adjustable connector, when pushed by the opposing connector, the movable guide may move relative to the housing to change the tolerance. Thus, the case in which the terminal of the opposing connector may be not connected to the terminal of the tolerance-adjustable connector may not occur. In conclusion, since it may not be necessary to strictly inspect and manage the dimensional defects of the connector, the manufacturing costs of the connector may be reduced, and A/S due to connection failure in electronic equipment or devices including the connector may be reduced.

The semifinished connector product provided with the housing and the movable guide may be molded through double injection to reduce manufacturing costs and improve productivity. In addition, when compared to the floating connector, the configuration and the manufacturing method are simple and thus improve the quality and the operation reliability and greatly reduce the manufacturing costs.

Terminologies used in this specification are terms used to appropriately express preferred embodiments, which may vary according to the intention of a user or operator or conventions in the fields. Therefore, definitions of these terms should be made based on the content throughout the entirety of this specification.

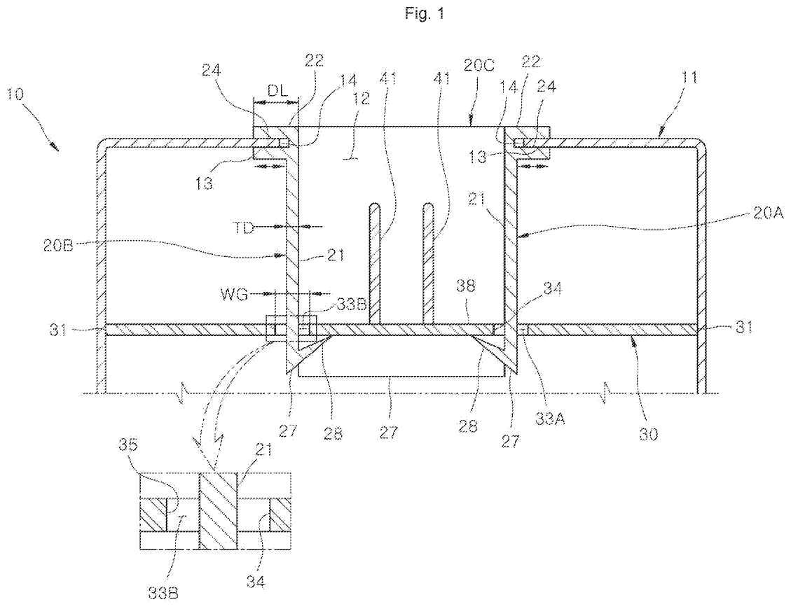

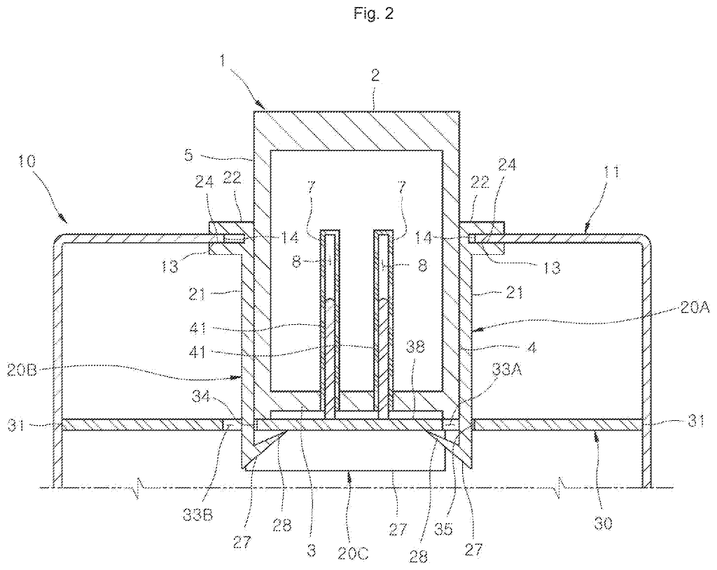

Referring to FIGS. 1 and 2 together, a tolerance-adjustable connector (10) may be a connector having a header seating groove into which an opposing connector (1) may be inserted. To elaborate, the opposing connector (1) may comprise a header (2) inserted into the header seating groove. A plurality of female terminals (7) may be provided on a front end (3) of the header (2) facing the header seating groove.

The tolerance-adjustable connector (10) may comprise a housing (11), a plurality of movable guides (20A, 20B, 20C), a guide holder (30), and a plurality of male terminals (41). The housing (11) may be made of a first synthetic resin and has an open through-hole (12) into which the header (2) of the opposing connector (1) may be inserted. The through-hole (12) may be defined by four straight edge portions (13) connected so that the planar shape may become an approximately quadrangular shape. Four movable guides (20A, 20C) may be provided to correspond one-to-one to the four edge portions (13). One of the four movable guides is not shown in the cross-sectional views of FIGS. 1 and 2.

Each of the plurality of movable guides (20A, 20B, 20C) may be made of a second synthetic resin that may not be bonded to the first synthetic resin. The plurality of movable guides (20A, 20B, 20C) may be in slidable contact with the housing (11) so as to be movable. For example, the housing (11) may comprise protrusions (14) protruding from the four edge portions (13) toward a center of the through-hole (12). One end (22) of each of the movable guides (20A, 20B, may have a protrusion guide groove (24) that may be recessed in the protruding direction of the protrusion (14) so that the protrusion (14) of the edge portion (13) may be inserted. Each of the plurality of movable guides (20A, 20B, 20C) may be movable substantially in parallel to the protruding direction of the protrusion (14) inserted into the protrusion guide groove (24).

In FIGS. 1 and 2, the protrusion may be formed on the edge portion (13), and the protrusion guide groove (24) may be formed on the one end (22) of each of the movable guides (20A, 20B, 20C), but is not limited thereto. Unlike illustrated in FIGS. 1 and 2, the protrusion may be formed on the one end (22) of each of the movable guides (20A, 20B, 20C), and the protrusion guide groove into which the protrusion may be inserted may be formed in the edge portion (13).

One of the first synthetic resin which may be the material of the housing (11) and the second synthetic resin which may be the material of each of the movable guides (20A, 20B, 20C) may be polytetrafluoroethylene (PTFE) which has a low surface friction coefficient. The other of the first synthetic resin and the second synthetic resin may be a synthetic resin having a higher surface friction coefficient than PTFE, such as, for example, an acrylonitrile butadiene styrene resin (ABS resin) or a polystyrene resin. PTFE has a melting point of approximately 330° C., whereas ABS resin and polystyrene resin have a melting point lower than 200° C.

Therefore, even if a member made of PTFE among the housing (11) and the movable guides (20A, 20B, 20C) may be injection-molded first, and the member injection-molded first may be inserted into a mold (not shown) and a molten resin of ABS resin or polystyrene resin may be injected into the mold, the member injection-molded first may not be melted. As a result, a semifinished connector product to which the housing (11) and the plurality of movable guides (20A, 20B, 20C) may be temporarily attached may be molded through double injection molding. A member made of PTFE and a member made of ABS resin or polystyrene resin may not be bonded to each other at an interface due to a large difference in properties such as a melting point, a frictional coefficient, density, and tensile strength.

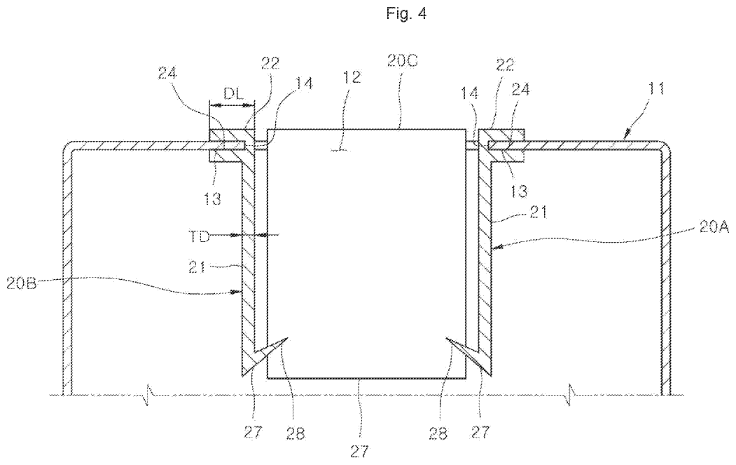

To elaborate, as illustrated in FIG. 4, in the semifinished connector product formed through double injection molding, the edge portion (13) of the housing (11) and the one end (22) of each of the plurality of movable guides (20A, 20B, may be temporarily attached with weak adhesive force, but when an operator presses the plurality of movement guides (20A, 20B, 20C) or the housing (11) with weak force, the plurality of movable guides (20A, 20B, 20C) and the housing (11) may be separated by using the edge portion (13) and the protrusion guide groove (24) as boundaries. Thus, the plurality of movable guides (20A, 20B, 20C) may be slidably supported on the edge portion (13) and may move in the protruding direction of the protrusion (14).

A plurality of movable guides (20A, 20B, 20C) may be provided with a hook (27) at a distal end, that is, the other end, and a flat plate part (21) connecting the one end (22) to the hook (27) disposed at the distal end. The flat plate part (21) may be formed with a thickness (TD) having a certain size. A plurality of guide through-holes (33A, 33B) through which the hooks (27) at the distal ends of the plurality of movable guides (20A, 20B, 20C) pass may be formed in a guide holder (30). The number of the plurality of guide through-holes (33A, 33B) may be the same as the number of the plurality of movable guides (20A, 20C).

Each of the plurality of guide through-holes (33A, 33B) may have a clearance so that the hooks (27) of the plurality of movable guides (20A, 20B, 20C) move with respect to the housing (11) while the hooks (27) pass therethrough. The size of the clearance may be a size obtained by subtracting the thickness (TD) of the plate part (21) from the width (WG) of each guide through-hole (33A, 33B), that is, ‘WG-TD’. The width (WG) of each of the guide through-holes (33A, 33B) may be defined as a distance between an outer edge (34) and an inner edge (35), which define the guide through-holes (33A, 33B).

The depth (DL) of the protrusion guide groove (24), which may be substantially parallel to the protruding direction of the protrusion (14), may be greater than the size (WG-TD) of the clearance between the plurality of guide through-holes (33A, 33B). Thus, even if the plurality of movable guides (20A, 20B, 20C) move substantially in parallel with the protruding direction of the protrusion (14) within a limit of the size of the clearance (WG-TD), a phenomenon in which the protrusion (14) may have escaped from the protrusion guide groove (24), and thus, the movable guides (20A, 20B, 20C) may be separated from the housing (11), and the housing (11) and the movable guides (20A, 20B, 20C) may be disassembled may not occur.

An outer circumferential portion (31) of the guide holder (30) may be fixedly coupled to the inner surface of the housing (11) so that the guide holder (30) may be installed inside the housing (11). The plurality of male terminals (41) may protrude toward the through-hole (12) of the housing (11) from a central portion (38) of the guide holder (30) surrounded by the plurality of movable guides (20A, 20B, 20C). The guide holder (30) may be a printed circuit board (PCB) for fixing and supporting the plurality of male terminals (41). The four movable guides (20A, 20B, 20C) slidably supported by the four edges (13) of the housing (11) and the header seating groove into which the header (2) of the opposing connector (1) may be inserted and seated by the central portion (38) of the guide holder (30) may be defined.

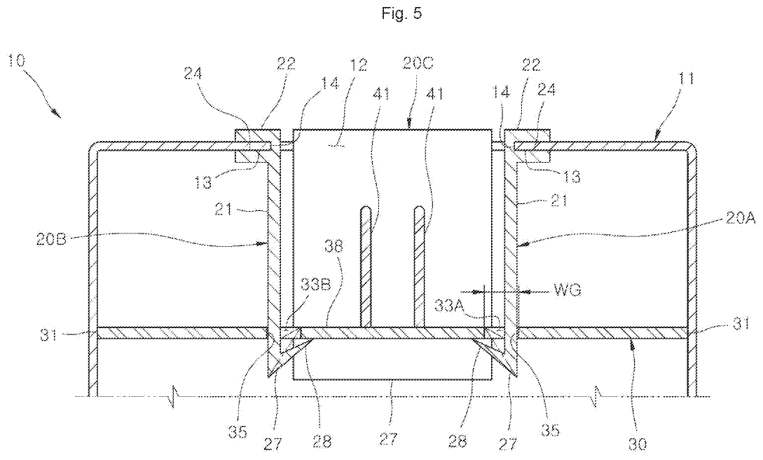

The hooks (27) of the movable guides (20A, 20B, 20C) may block the distal end of the movable guides (20A, 20B, 20C) so that the distal end may pass through the guide through-holes (33A, 33B) in one direction and then may pass through the through-holes in the opposite direction. To elaborate, as shown by a dotted-dashed line in FIG. 5 when the movable guides (20A, 20B, 20C) move relative to the guide holder (30) in a direction substantially parallel to the direction from the one end (22) of the movable guides (20A, 20B, 20C) toward the distal end so that the hooks (27) pass through the guide through-holes (33A, 33B), an inclined piece (28) of the hooks (27) may be pushed by the inner edge (35) of the guide through-holes (33A, 33B) and may be folded to approach the flat plate part (21), and thus, the hooks (27) may pass through the guide through-holes (33A, 33B). When the inclined piece (28) of the hook (27) completely passes through the guide through-holes (33A, 33B), the inclined piece (28) of the hook (27) may be elastically restored and unfolded, as shown by a solid line in FIG. 5.

In this state, when the movable guides (20A, 20B, 20C) move with respect to the guide holder (30) in the direction substantially parallel to the direction from the distal end of the movable guides (20A, 20B, 20C) toward the one end (22), the inclined piece (28) of the unfolded hook (27) may be hooked on the central portion (38) of the guide holder (30) so that the distal end of the movable guides (20A, 20B, 20C), that is, the hook (27) may pass through the guide through-holes (33A, 33B). As a result, when the movable guides (20A, 20C) are inserted into the guide through-holes (33A, 33B) of the guide holder (30) due to the hook (27), the movable guides (20A, 20B, 20C) may not escape and separate from the guide holder (30). On the other hand, in FIGS. 1 and 2, the hook (27) may be provided with the inclined piece (28) extending bent toward the central portion (38) of the guide holder (30), but this is exemplary, and the hook (27) may be provided with an inclined piece extending bent toward the outer circumferential portion (31) of the guide holder (30).

When it is intended to connect the opposing connector (1) to the tolerance-adjustable connector (10) in an electrically conductive manner, the operator holds the header (2) of the opposing connector (1) and aligns the plurality of female terminals (7) with the plurality of male terminals (41) to push the header (2) into the through-hole (12). At this time, a distance from one side surface (4) of the header (2) to the plurality of female terminals (7) may be greater than a distance from the one movable guide (20A) corresponding to the one side surface (4) to the plurality of male terminals (41). In this case, the one movable guide (20A) may be pushed by the one side surface (4) of the header (2) to move relative to the housing (11). For example, in the one movable guide (20A), the protrusion (14) of the edge portion (13) slides in the protrusion guide groove (24) to move in a direction away from the plurality of male terminals (41).

Thus, the header (2) enters the inside of the through-hole (12), and the plurality of male terminals (41) may be inserted into terminal holes (8) of the plurality of female terminals (7) so that the plurality of male terminals (41) and the plurality of female terminals (7) may be in contact with each other in an electrically conductive manner. When the front end (3) of the header (2) is in contact with the central portion (38) of the guide holder (30), the header (2) of the opposing connector (1) may be inserted and seated in the header seating groove that may be defined by the four movable guides (20A, 20B, 20C) and the central portion (38) of the guide holder (30).

On the other hand, when the header (2) is seated in the header seating groove, the other side surface (5) of the header (2) may be spaced apart from the other movable guide (20B). In this case, the operator may lightly push the other movable guide (20B) toward the other side surface (5) of the header (2) so that the other movable guide (20B) may be in contact with the other side surface (5) of the header (2). As a result, foreign matter such as dust may be prevented from infiltrating a gap between the other movable guide (20B) and the other side surface (5) of the header (2).

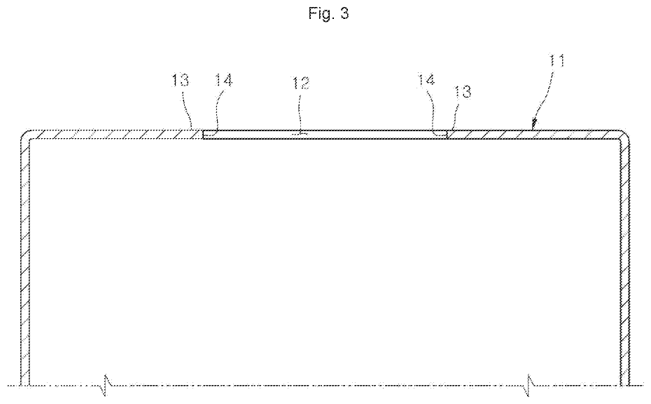

FIGS. 3 to 5 are cross-sectional views sequentially illustrating a method for manufacturing the tolerance-adjustable connector of FIG. 1. Referring to FIGS. 1, 3, to 5 together, a method for manufacturing the tolerance-adjustable connector (10) according to an aspect of the disclosure may comprise a double injection molding step (S10), a guide holder preparation step (S20), a guide holder installation step (S30), and a movable guide separation step (S40). The double injection molding step (S10) may be a step of molding a semifinished connector product provided with a housing (11) made of a first synthetic resin and a plurality of movable guides (20A, 20B, 20C) made of a second synthetic resin and temporarily attached to the housing (11) through double injection molding.

A specific method of the double injection molding step (S10) may vary depending on the types of the first synthetic resin and the second synthetic resin. For example, the melting point of the first synthetic resin may be higher than the melting point of the second synthetic resin. For example, the first synthetic resin may be PTFE, and the second synthetic resin may be an ABS resin or a polystyrene resin. The double injection molding step (S10) may comprise a housing molding step (S11) of injection-molding the housing (11) made of the first synthetic resin (see FIG. 3), and a semifinished connector product molding step (S12) of fixing the housing (11) inside a mold (not shown) having a cavity corresponding to a shape of the semifinished connector product after the housing molding step (S11) and injecting the molten resin of the second synthetic resin into the cavity and curing same to mold the semifinished connector product (see FIG. 4).

A housing injection molding mold (not shown) for injection-molding the housing (11) and a semifinished connector injection molding mold (not shown) for molding the semifinished connector product may be separate molds. Alternatively, the housing molding step (S11) and the semifinished connector product molding step (S12) can be completed in a shorter time by using the double injection molding mold (not shown) in which the housing injection molding mold and the semifinished product injection molding mold may be coupled to each other to form one mold.

The melting point of the second synthetic resin may be higher than the melting point of the first synthetic resin. For example, the second synthetic resin may be PTFE, and the first synthetic resin may be an ABS resin or a polystyrene resin. The double injection molding step (S10) may comprise a movable guide molding step (S16) of injection-molding a plurality of movable guides (20A, 20B, 20C) made of the second synthetic resin, and a semifinished connector product molding step (S17) of fixing the plurality of movable guides (20A, 20B, 20C) inside a mold (not shown) having a cavity corresponding to a shape of the semifinished connector product after the movable guide molding step (S16) and injecting the molten resin of the second synthetic resin into the cavity and curing same to mold the semifinished connector product.

The movable guide injection molding mold (not shown) for injection-molding the plurality of movable guides (20A, 20B, 20C) and the semifinished connector injection molding mold (not shown) for molding the semifinished connector product may be separate molds. Alternatively, the movable guide housing molding step (S16) and the semifinished connector product molding step (S17) can be completed in a shorter time by using the double injection molding mold (not shown) in which the movable guide injection molding mold and the semifinished product injection molding mold may be coupled to each other to form one mold.

The guide holder preparation step (S20) may be a step of preparing a guide holder (30) in which a plurality of guide through-holes (33A, 33B) having a clearance may be formed, and a plurality of male terminals (41) may be fixedly installed. Referring to FIG. 5, the guide holder installation step (S30) may be a step of installing the guide holder (30) inside the housing (11) so that the hooks (27) on the distal end of the plurality of movable guides (20A, 20B, 20C) pass through the plurality of guide through-holes (33A, 33B). As described above, while the hooks (27) may pass through the guide through-holes (33A, 33B), an inclined piece (28) of the hook (27) may be folded and then elastically restored and unfolded, and the plurality of movable guides (20A, 20B, 20C) may not escape and separate from the guide through-holes (33A, 33B) of the guide holder (30).

The movable guide separation step (S40) may be a step of pressing the plurality of movable guides (20A, 20B, 20C) so that one end (22) of the plurality of movable guides (20A, 20B, 20C) may be separated from an edge portion (13) and a protrusion (14) of the housing (11) by using the protrusion guide groove (24) as a boundary and may slidably move relative to the housing (11) along the protruding direction of the protrusion (14). Each of the movable guides (20A, 20B, 20C) may be hit or pushed with weak force using a hand of the operator or a tool so that each of the movable guides (20A, 20B, 20C) may be separated from the edge portion (13) and the protrusion (14). The state in which the plurality of movable guides (20A, 20B, 20C) may be slidably separated from the edge portion (13) and the protrusion (14) with respect to the housing (11) is illustrated in FIG. 1.

When the tolerance-adjustable connector (10) described above is pushed by the opposing connector (1), the movable guides (20A, 20B, 20C) may move relative to the housing (11), and thus, a tolerance may be changed. Thus, there may be no instances in which the terminal (7) of the opposing connector (1) and the terminal (41) of the tolerance-adjustable connector (10) may not be connected to each other. In conclusion, since it may not be necessary to strictly inspect and manage dimensional defects of the tolerance-adjustable connector (10), the manufacturing costs of the connector (10) are reduced, and A/S due to connection failure in electronic equipment or devices including the connector (10) may be reduced.

In addition, the semifinished connector product provided with the housing (11) and the movable guides (20A, 20B, 20C) may be molded through double injection to reduce manufacturing costs and improve productivity. In addition, when compared to the floating connector, the configuration and the manufacturing method are simple and thus improve the quality and the operation reliability and greatly reduce the manufacturing costs.

The disclosure has been described with reference to aspects illustrated in the drawings, but this is only exemplary, and those skilled in the art will understand that various modifications and equivalent other embodiments are possible.

1. A tolerance-adjustable connector, comprising:
housing made of a first synthetic resin; and
a movable guide that is made of a second synthetic resin that is not bonded to the first synthetic resin, is in slidable contact with the housing, and is movable relative to the housing.

2. The tolerance-adjustable connector of claim 1, wherein
one of the housing and the movable guide is provided with a protrusion,
the other of the housing and the movable guide has a protrusion guide groove recessed in a protruding direction of the protrusion so that the protrusion is inserted, and
the movable guide is movable substantially parallel to the protruding direction of the protrusion.

3. The tolerance-adjustable connector of claim 1, wherein
the movable guide is provided in a plurality,
a through-hole is formed in the housing, and
the plurality of movable guides are slidably supported on an edge portion that defines the through-hole.

4. The tolerance-adjustable connector of claim 1, further comprising:
a guide holder having a guide through-hole through which the movable guide passes and which has a clearance so that the movable guide moves relative to the housing while the movable guide passes therethrough.

5. The tolerance-adjustable connector of claim 4, wherein
the movable guide is provided with a hook at a distal end thereof so that the distal end of the movable guide passes through the through-hole in one direction and then cannot pass through in the opposite direction to said direction.

6. The tolerance-adjustable connector of claim 1, wherein
one of the first synthetic resin and the second synthetic resin is polytetrafluoroethylene (PTFE).

7. The tolerance-adjustable connector of claim 6, wherein
the other of the first synthetic resin and the second synthetic resin is one of an acrylonitrile butadiene styrene resin (ABS resin) and a polystyrene resin.

8. A method for manufacturing a tolerance-adjustable connector, comprising:
a double injection molding step of forming a semifinished connector product provided with a housing made of a first synthetic resin and a movable guide made of a second synthetic resin and temporarily attached to the housing through double injection molding; and
a movable guide separation step of pressing the movable guide so that the movable guide is separated from the housing to be able to move relative to the housing.

9. The method for manufacturing the tolerance-adjustable connector of claim 8, wherein
the melting point of the first synthetic resin is higher than the melting point of the second synthetic resin, and
the double injection molding step comprises:
a housing molding step of injection-molding the housing made of the first synthetic resin; and
a semifinished connector product molding step of fixing the housing inside a mold having a cavity corresponding to a shape of a semifinished connector product and injecting the molten resin of the second synthetic resin into the cavity and curing same to mold the semifinished connector product.

10. The method for manufacturing the tolerance-adjustable connector of claim 9, wherein
the first synthetic resin is PTFE.

11. The method for manufacturing the tolerance-adjustable connector of claim 8, wherein
the melting point of the second synthetic resin is higher than the melting point of the first synthetic resin, and
the double injection molding step comprises:
a movable guide molding step of injection-molding the movable guide made of the second synthetic resin; and
a semifinished connector product molding step of fixing the movable guide inside a mold having a cavity corresponding to a shape of the semifinished connector product and injecting the molten resin of the second synthetic resin into the cavity and curing same to mold the semifinished connector product.

12. The method for manufacturing the tolerance-adjustable connector of claim 11, wherein
the second synthetic resin is PTFE.

13. The method for manufacturing the tolerance-adjustable connector of claim 8, further comprising:
a guide holder preparation step of preparing a guide holder in which a guide through-hole having a clearance is formed; and
a guide holder installation step of installing the guide holder inside the housing so that the movable guide passes through the guide through-hole.
